(19) United States
(12) Patent Application Publication
(10) Pub. No.: US 2005/0272416 A1
(43) Pub. Date: Dec. 8, 2005

(54) Personalization of accessories coupled to a communications device

(76) Inventors: Thean Hai Ooi, Penang (MY); Samuel Chia, Pulau Pinang (MY); Fook Teng Fam, Penang (MY); Tee Hoh Quah, Penang (MY); Cheah Heng Tan, Penang (MY); Kelvin Teh, Penang (MY); Clement Pakiam Tobias Xavier, Penang (MY)

Correspondence Address: MOTOROLA, INC., 1303 EAST ALGONQUIN ROAD, IL01/3RD, SCHAUMBURG, IL, 60196, US

(21) Appl. No.: 10/863,171

(22) Filed: Jun. 8, 2004

(51) Int. Cl. H04M 3/00

(52) U.S. Cl. 455/418; 455/410

(57) ABSTRACT

A communications device (100) and method (200) for automatically personalizing user interface parameters of an accessory (120,140) operatively coupled to the communications device (100). The communications device (100) and the method (200) provide for reading (260) a pre-defined user interface setting stored in a memory of the accessory, the reading being performed by the communications device (100) and the pre-defined user interface settings being pre-selected by a user of the accessory (120,140). Thereafter, the communications device (100) and the method (200) effect a controlling (270) of a user interface parameter of the accessory (120,140), the controlling being effected in response to the reading (260) of the pre-defined user interface setting.

### FIELD OF THE INVENTION

This invention relates in general to a method and a communications device for automatic personalization of accessories operatively coupled to such a communications device. The invention is particularly useful for, but not necessarily limited to, personalization of accessories operatively coupled to two-way radios.

### BACKGROUND OF THE INVENTION

Many of today's communications devices, such as two-way radios and cellular telephones, connect to an array of accessories such as Public Speaker Microphones (PSMs) and Vehicular Adaptors (VAs). Some of these accessories, often referred to as “smart” accessories, contain an embedded non-volatile memory. When the accessory is operatively coupled to a communications device, the embedded non-volatile memory is used to provide data that identifies the accessory and its associated features (functions) that complements or replaces features of the communications device. When a “smart” accessory with an embedded non-volatile memory is operatively coupled to a communications device, the data contents of the non-volatile memory, such as accessory device type and function capability data (features), can be read by the device's processor. An example of an embedded non-volatile memory is a 1-Wire® bus Electrically Erasable Programmable Read Only Memory (EEPROM) available from Dallas Semiconductor. A 1-Wire® bus is a single wire power and data communications bus system that has a single bus master, typically-a microcontroller, and one or more slaves.

Today, there is a trend towards allowing multiple accessories to be operatively coupled to a specific two-way radio. Such two-way radios are designed to provide an audio interface to an attached audio accessory and the audio response of an accessory is largely determined by the accessory's acoustic response. Furthermore, the radio's audio processing capability is normally designed for the radio's internal acoustic elements. However, since the acoustic response of the accessory and the radio differ because of their different components and acoustic characteristics of their respective housings, the accessory typically operates at an audio quality level lower than that provided by the audio quality provided solely from the radios audio interface.

In view of the above, variations of audio characteristics between different accessories when coupled to particular two-way radio are often noticed by a user. For example, a remote speaker microphone (RSM) with omni-directional microphones has a substantially different voice response compared to an RSM with the same housing but having a noise-canceling microphone element. Also, there is a trend towards each user having their own accessories and sharing two-way radios or users sharing many accessories and two-way radios from a company's pool of such devices. For instance, security shift workers may have their own accessories and simply collect a two-way radio, from a pool of radios, when they arrive at work.

The settings of microphone gain, speaker gain and Liquid Crystal Display settings can vary considerably for each user. In this regard, one user may speak loudly and thus an accessory would require reduced microphone gain otherwise speech distortion may occur due to signal clipping of the user's processed speech. In contrast, another user may speak softly and therefore it would be beneficial if the microphone gain is set relatively high or even at a maximum setting. Furthermore, one user may have impaired hearing and therefore requires the speaker gain to be set to maximum whereas another user may have sensitive hearing and requires the speaker gain to be set much lower. Similar requirements can apply to Liquid Crystal Display settings supported by a particular accessory. Accordingly, inconvenience and time wasting occurs when a user, for instance, has to modify microphone gain, speaker gain or Liquid Crystal Display settings every time he/she collects a radio from pool of radios at the start of a working day or shift.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a communications device for automatically personalizing user interface parameters of an accessory operatively coupled thereto, the communications device comprising:
a processor;
a user interface operatively coupled to the processor; and
an accessory port operatively coupled to the processor, wherein in use when an accessory is operatively coupled to the accessory port the processor provides for reading of at least one pre-defined user interface setting pre-selected by a user of the accessory and stored in a memory of the accessory, and controlling at least one user interface parameter of the accessory, the controlling being effected by the processor in response to the reading of at least one pre-defined user interface setting.

According to another aspect of the invention there is provided a method for automatically personalizing user interface parameters of an accessory operatively coupled to a communications device, the method comprising:
reading of at least one pre-defined user interface setting stored in a memory of the accessory, the reading being performed by the communications device and the pre-defined user interface settings being pre-selected by a user of the accessory; and
controlling at least one user interface parameter of the accessory, the controlling being effected by the communications device in response to the reading of at least one pre-defined user interface setting.

Suitably, the pre-defined user interface setting is a pre-defined audio characteristic setting.

Preferably, the reading is further characterized by the pre-defined user interface setting including microphone gain. Suitably, the pre-defined audio characteristic settings may include speaker gain.

Suitably, the controlling is characterized by the communications device directly controlling the user interface parameter.

Suitably, the user interface parameter may include an audio parameter.

Suitably, the user interface parameter is associated with a visual display.

Preferably, the method includes a prior step of detecting operatively coupling of the accessory.

Suitably, the method includes a prior step of obtaining user identification data for identifying the pre-defined user interface settings.

Suitably, the accessory is addressed by use of an accessory identifier stored in an embedded memory of the accessory.

Preferably, the pre-defined user interface setting is stored in the memory of the accessory prior to operative coupling of the accessory to the communications device.

Suitably, the pre-defined user interface setting is selected by:
adjusting an interface parameter of the accessory, the adjusting being performed by a user of the accessory to provide a personalized interface parameter; and
generating the pre-defined user interface setting from personalized interface parameter; and
storing the pre-defined user interface setting.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of a communications device in the form of a two-way radio with operatively coupled accessories in accordance with the present invention;

FIG. 2 is a flow diagram illustrating a method for automatically personalizing user interface parameters of accessories operatively coupled to a communications device of FIG. 1 in accordance with the present invention; and

FIG. 3 is a flow diagram illustrating a method for selecting pre-defined setting stored in a memory of an accessory operatively coupled to the communications device of FIG. 1 in accordance with the present invention.

### DETAILED DESCRIPTION OF THE PREFERRED EMBODIMENT OF THE INVENTION

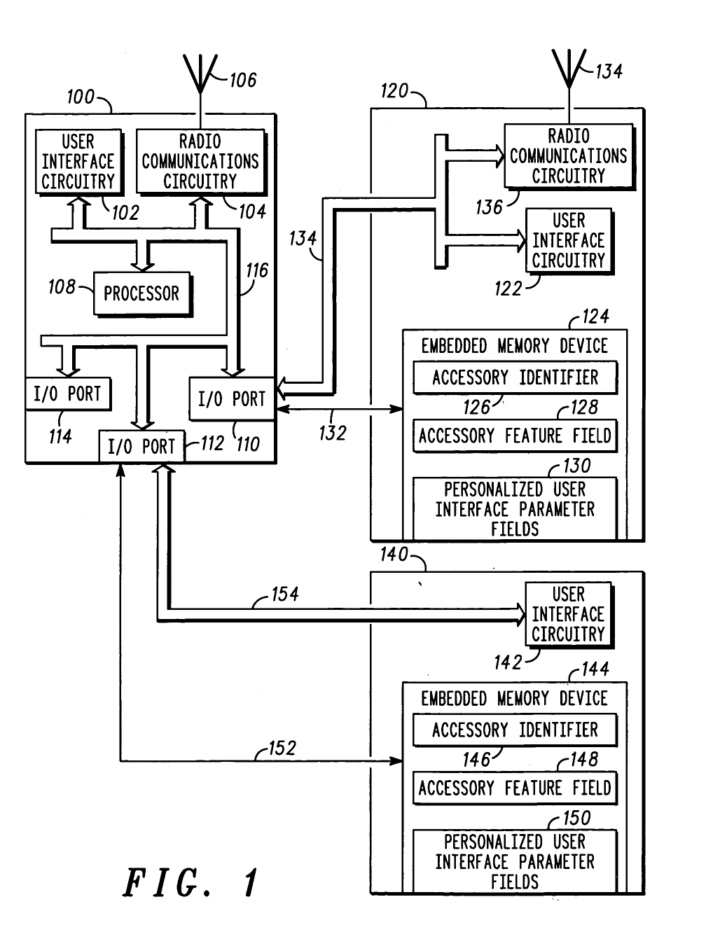

In the drawings, like numerals on different Figures are used to indicate like elements throughout. Referring now to FIG. 1, there is illustrated a schematic block diagram of a communications device in the form of a two-way radio 100 in accordance with a preferred embodiment of the present invention. The two-way radio 100 is operatively coupled to two remote accessories 120,140. The remote accessories 120,140 can be typically selected from a group of accessories including: a remote speaker microphone, a Public Speaker Microphone (PSM), a headset, a Vehicular Adapter (VA) or other accessory. The two-way radio 100 includes a processor 108, a user interface 102 operatively coupled to the processor 108 by a data and address bus 116. Also, Input Output (I/O) ports in the form of accessory ports 110,112,114 are operatively coupled to the processor 108 by the data and address bus 116. In this preferred embodiment the accessory ports 110,112,114 include a conventional bus interface (CBI) and an additional 1-Wire® bus interface. Although, in this preferred embodiment, there is an additional 1-Wire® bus interface is used for its simplicity, those skilled in the art will recognize parallel and other serial bus memories may be used. For instance, the CBI could be used to replace the functionality of the 1-Wire® bus interface.

The two-way radio 100 also has radio communications circuitry 104 operatively coupled to an antenna 106 through an antenna port, the radio communications circuitry 104 also being operatively coupled to the processor 108 by the data and address bus 116. The radio communications circuitry 104 includes a Radio Frequency (RF) Amplifier, Modulation and Demodulation Circuitry, Frequency Synthesis Circuitry, filtering circuitry and other typical RF circuitry as will be apparent to a person skilled in the art.

Both of the accessories 120, 140 include respective user interface circuitry 122,142, which may include, amongst others, optional switches, a speaker and/or microphone and may also include a visual display unit. Also, accessory 120 includes radio frequency communications circuitry 132 coupled to an antenna 134. In accordance with the present invention, accessories 120,140 include a respective embedded non-volatile memory often called an Embedded Memory Device (EMD) 124,144 such as a 1-Wire® EEPROM. The Embedded Memory Device (EMD) 124 contains an accessory identifier 126, an accessory feature field 128 and personalized user interface parameter fields 130. Similarly, the Embedded Memory Device EMD 144 contains an accessory identifier 146, an accessory feature field 148 and personalized user interface parameter fields 150.

As illustrated, accessory 120 is a Public Speaker Microphone (PSM) and therefore has radio communications circuitry 136 operatively coupled to an antenna 134 through an antenna port. The radio communications circuitry 132 includes a Radio Frequency (RF) Amplifier, Modulation and Demodulation Circuitry, Frequency Synthesis Circuitry, filtering circuitry and other typical RF circuitry as will be apparent to a person skilled in the art.

The user interface circuitry 122 and radio communications circuitry 136 of accessory 120 are operatively coupled to the accessory port 110 by a conventional bus architecture 134. Also, the embedded memory device (EMD) 124 is operatively coupled to accessory port 110 by a 1-Wire® bus 132 that includes power supply conductors (VCC and Ground) for providing power to accessory 120. Similarly, the user interface circuitry 142 of accessory 140 is operatively coupled to accessory port 112 by a conventional bus architecture 154. Also, the embedded memory device (EMD) 144 is operatively coupled to accessory port 112 by a 1-Wire® bus 152 that includes power supply conductors (VCC and Ground) for providing power to accessory 140.

As described above, in this embodiment, the respective embedded memory devices (EMDs) 124, 144, for each of the respective accessories 120, 140, is a 1-Wire® bus EEPROM with 4 bytes allocated for the Accessory Identifier 126 or 146. The Accessory Identifier 126 or 146 is used to look up the barest accessory characteristics stored in memory in the processor 108. Table 1 shows the memory organization hierarchy for both of the embedded memory devices (EMDs) 124,144.

TABLE 1

| Memory Offset (Hex) | Contents |
|---|---|
| 0x0000 | 4-byte Accessory ID String |
| 0x0004 | 2-byte Accessory Feature |
| | Field |
| 0x0006 | 4-byte personalized user |
| | interface parameter field |
| 0x000A | 4-byte personalized user |
| | interface parameter field |
| . . . | . . . |
| -EOF- | blank space (don't care) |

In accordance with the present invention, the personalized user interface parameter fields 130, 150 are 4-byte coded fields embodying information about the audio capability or acoustic performance of their respective accessories 120, 140. Each of the interface parameter fields 130, 150 includes a 4 bit user identifier code and corresponding personalized: audio parameters and Liquid Crystal Display settings. In a given accessory, for instance accessory 120, the 4 most significant bits (bits 32 to 35) of one of the personalized user interface parameter fields 130 comprises an user identifier sub-field. Hence, 16 users may have their personalized preferences stored in a respective one of the available fields 130. Each user identifier sub-field essentially functions as an implied address, for example, memory offset addresses 0x0006 to 0x00009 are reserved for identifier sub-field 0000; memory offset addresses 0x001A to 0x001D are reserved for identifier sub-field 0101, and memory offset addresses 0x001E to 0x0021 are reserved for identifier sub-field 0110.

The next most 8 most significant bits (bits 24 to 31) of the personalized user interface parameter fields 130 are dedicated to audio parameters. More specifically bits 24 to 27 are dedicated to speaker volume/gain and bits 28 to 31 are dedicated to microphone sensitivity/gain. The least significant 24 bits (bits 0 to 23) of the personalized user interface parameter fields 130 are dedicated to Liquid Crystal Display settings including: color/grey scale, brightness, contrast and font size. The accessory feature fields 128, 148 are 2-byte coded fields that identify up to 16 features provided by the accessories 120 or 140. For example, the Least Significant Bit (LSB) identifies an audio output feature is available on the accessory. The second LSB identifies an audio input feature is available, the third LSB indicates that a radio communications feature is available on the accessory and the fourth LSB indicated that a visual display feature is available that is typically a Liquid Crystal Display. Thus, for instance, considering accessory 120 the four LSBs of the accessory feature field 128 could be 1111 thereby identifying: audio output feature; an audio input feature; a frequency communications feature and a visual display feature are supported. In contrast, considering accessory 140 the four LSBs of the accessory feature field 148 could be 1011 thereby identifying: audio output feature, an audio input feature and a visual display feature (the “0” in the third LSB indicates there is no frequency communications feature available/supported by accessory 140).

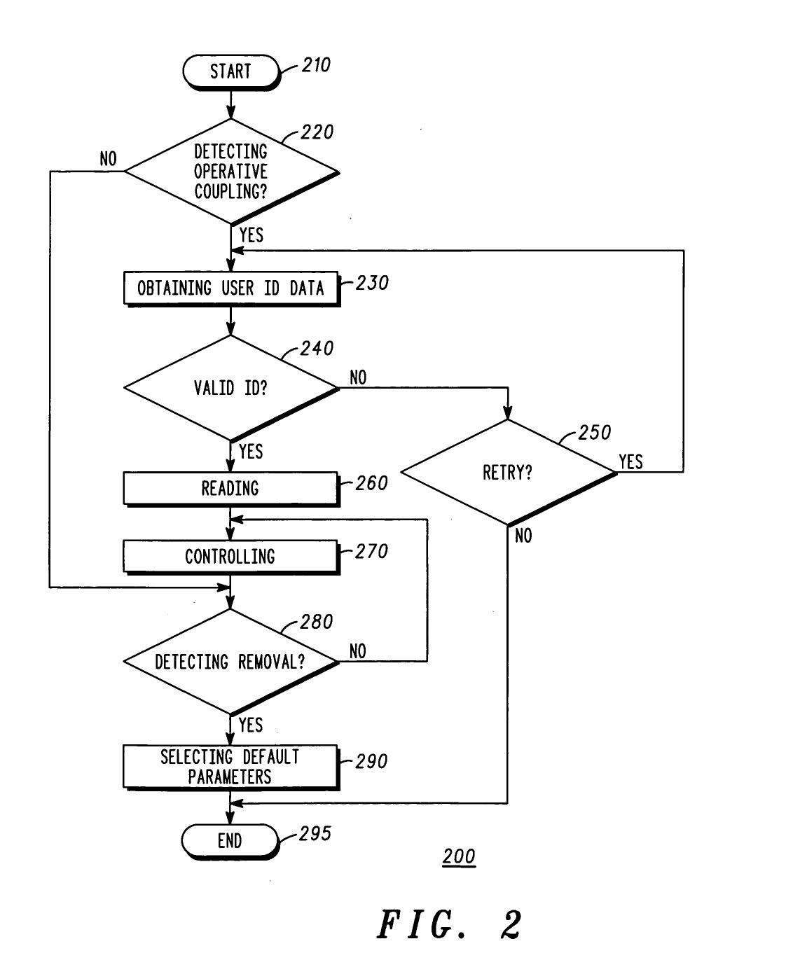

Referring to FIG. 2 there is a flow diagram illustrating a method 200 for automatically personalizing user interface parameters of accessories 120, 140 that are operatively coupled to the two-way radio 100. The method 100 is initiated by a start routine 210 that is invoked by an interrupt being provided to the processor 108 that occurs when an accessory is connected or disconnected (operatively coupled or decoupled) to one of the ports 110,112,114. After the start routine 210 the method 200 performs a step of detecting 220 for detecting operative coupling of an accessory (e.g. accessory 120 or 140) to the two-way radio 100.

If operative coupling occurs, for instance with the coupling of accessory 120, the accessory is addressed by reading the accessory identifier 126 thereby the processor 108 links the accessory identifier with the port 110,112, 114 to which the accessory 120 is coupled. The method 200 then performs an optional step 230 of obtaining user identification data that may simply be provided by a user entering an identification number between 0 to 15 at the user interface circuitry 122 or 102. If the user enters an identification number, for instance number 5, then this number will be used to identify which of the personalized user interface parameter fields 130 has an user identifier sub-field of “0101”. The method 200 then provides for checking if the identification number is valid at a Valid Identification (ID) test step 240 by searching each user identifier sub-field stored in the personalized user interface parameter fields 130.

If the identification number is not found in the user interface parameter fields 130 at test step 240, then a retry request is sent to the user interface circuitry (122 or 102) by processor 108 at a retry test step 250. If the user wishes to retry then he/she enters a retry command, then after the retry test step 250 the method 200 returns to step 230. Alternatively, if the user does not wish to retry then he/she enters the appropriate response and after the retry test step 250 the method 200 goes to and end step 295 and terminates.

Returning to step 240, if the identification number is found in one of the user identifier sub-fields of the user interface parameter fields 130, then a step of reading 260 is performed that provides for reading at least one of pre-defined user interface setting stored in a memory of the accessory 120. The reading is performed by the radio 100 and the pre-defined user interface settings are pre-selected by a user of the accessory (as described below) and stored prior to operative coupling of the accessory 120 being as detected at step 220. More specifically, every pre-defined user interface setting is stored in one of the personalized user interface parameter fields 130 and is identified (addressed) by the user identification number. For instance, assuming the user identification data obtained at step 230 is 0101 then the memory offset addresses 0x001A to 0x001D are selected to identify a required one of the personalized user interface parameter fields 130 or 150. The bits 0 to 31 in the parameter field having its most significant bits set to 0101 are therefore read at the step of reading 260.

After the step of reading 260, a step of controlling 270 is performed and provides for controlling at least one user interface parameter of the accessory 120, the controlling being effected by the two-way radio 100 in response to the step of reading 260 performing the reading of at least one pre-defined user interface setting. The controlling 270 is performed by the two-way radio 100 directly controlling the user interface parameter via the conventional bus architecture 134. For instance, assuming that the user identification data obtained at step 230 is 0101, then bits 0 to 31 in the addressed parameter field having its most significant bits set to 0101 are used by processor 108 to control a user interface (Microphone, Speaker or a Display) of the accessory 120 coupled to the two-way radio 100. Hence, if bits 0 to 23 of the addressed parameter field are set to zero then there are no pre-defined user interface settings for the accessory's display and any other values identify a pre-defined user interface setting. If bits 24 to 27 are set to zero then there are no pre-defined user interface settings for the accessory's speaker volume/gain and any other values identify a pre-defined user interface setting. Similarly, if bits 28 to 31 are set to zero then there are no pre-defined user interface settings for the accessory's microphone sensitivity/gain and any other values identify a pre-defined user interface setting.

After the step of controlling 270 the method 200 performs a detecting removal test step 280. The detecting removal test step 280 is also performed if the step of detecting 220 does not detect a new operative coupling of an accessory to the two-way radio 100. If the detecting removal test step 280 does not detect a removal of one of the accessories (removal of an operative coupling of an accessory) the method 200 goes to the controlling step 270. Alternatively, if the detecting removal test step 280 detects removal of the accessory 120, then at a selecting step 290, default parameters are selected by the radio 100 for any interface parameters that were provided by the removed accessory. For example, if there is only one accessory (accessory 120) operatively coupled to the radio 100, and the accessory provides a speaker and microphone feature to the radio 100, then after the removal of this accessory the removal step 290 provides for searching default parameters for the radio's internal microphone and speaker included in the user interface circuitry 102. These default parameters are stored in internal memory of the processor 108 and control the gain/sensitivity of the radio's internal microphone and speaker. The method 200 then terminates at the end step 295.

When the two-way radio 100 is not operatively coupled to any accessories, the two-way radio 100 operates using the default parameters that may be overridden by the user adjusting the gain/sensitivity of the speaker or microphone via the user interface circuitry.

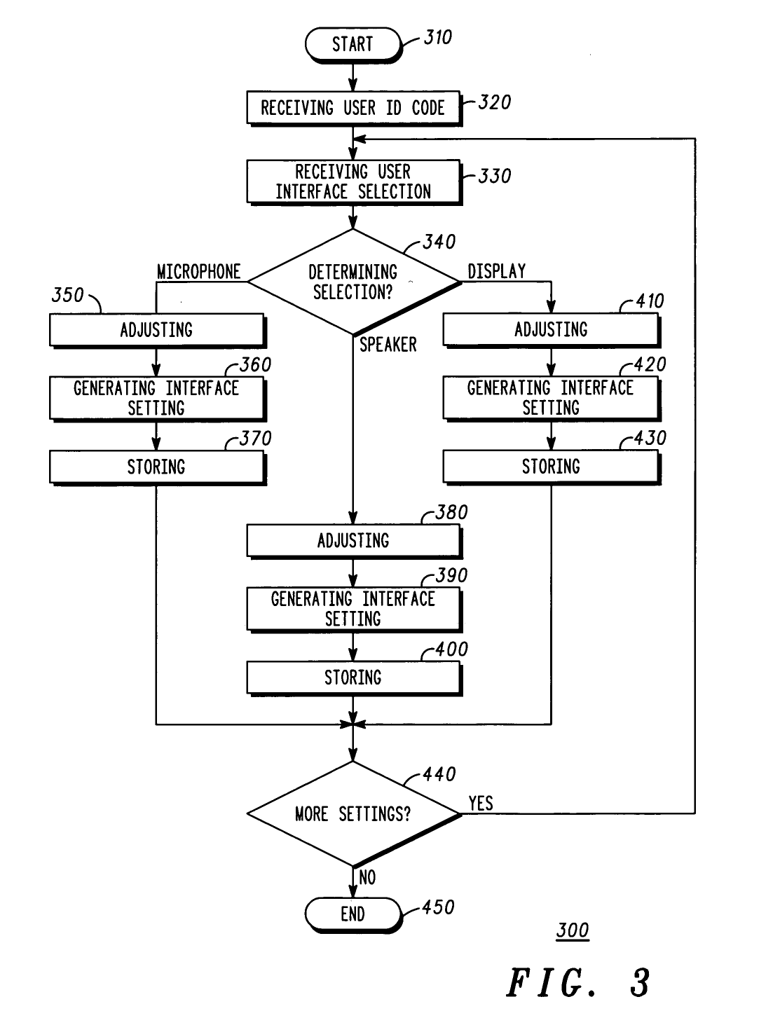

Referring to FIG. 3 there is illustrated a method 300 for selecting pre-defined setting stored in the memory (EMD) of an accessory, for example accessory 120, operatively coupled to the two-way radio 100. The method 300 starts at a start step 310 by a user choosing, via the user interface circuitry 102, an option to set his/her personal user interface settings. After the start step 310 the method 100 performs a step of receiving 320 that provides for receiving a user identification code that is input by the user. In this embodiment the user identification code is equivalent to the four bit user identification data stored in the personalized user interface parameter fields 130 or 150. After the user enters an available user identification code, for example 5 that is equivalent to binary 0101 (or selects a previously used user identification code), a step of receiving 330 is performed. As will be apparent to a person skilled in the art, the user identifier code could be linked to a user name that is displayed by the user interface circuitry 102 for user verification and cross checking. Also, the user identifier code could be password protected to limit unauthorized modifications to a user's pre-defined settings. The step of receiving 330 provides for receiving a user interface selection that is input (chosen) by the user, thereafter the method 300 performs a determining selection test 340 to determine what user interface selection was chosen by the user.

If for instance, the interface selection chosen was “microphone” then the method 300 performs a step of adjusting 350 that provides for adjusting interface parameters of the accessory 120 to provide a personalized interface parameter. During adjusting 350 the user has the option to modify the microphone's gain/sensitivity that comprises part of the user interface circuitry 122. Once the personalized microphone's gain/sensitivity is adjusted to the requirements of the user, the processor 108 uses a look up table at a generating interface setting step 360 to generate (select) a pre-defined user interface setting for microphone gain or sensitivity by referring to the personalized interface parameter. As will be apparent to a person skilled in the art, the microphone gain is the gain used to amplify signals received from the microphone that comprises part of the user interface circuitry of the accessory 120. At a storing step 370 the pre-defined user interface setting for microphone gain or sensitivity is stored in the personalized user interface parameter fields 130. More specifically, in this example, the user identification code 0101 is stored in bits 31 to 35 and the microphone gain setting is stored in bits 28 to 31 of the personalized user interface field 130 of memory offset addresses 0x001A to 0x001D.

The method 300 then performs a more settings test 440 to determine if the user inputs a request at the user interface circuitry 102 in order to set more of his/her personal user interface settings. If the user does not require to set any more personal user interface settings the method 300 terminates at an end step 450. However, if the user wishes to set more personal user interface settings then the method 300 returns to the step of receiving 330 and thereafter the method 300 again performs the determining selection test 340 to determine what user interface selection was chosen by the user.

If for instance, this time the interface selection chosen was “Speaker” then the method 300 performs a step of adjusting 380 that provides for adjusting interface parameters of the accessory 120 to provide a personalized interface parameter. During adjusting 380 the user has the option to modify the speaker's gain/sensitivity that comprises part of the user interface circuitry 122. Once the personalized speaker's gain/sensitivity is adjusted to the requirements of the user, the processor 108 uses the look up table at a generating interface setting step 390 to generate (select) a pre-defined user interface setting for speaker gain or sensitivity by referring to the personalized interface parameter. As will be apparent to a person skilled in the art, the speaker gain is the gain used to amplify signals sent to the speaker that comprises part of the user interface circuitry of the accessory 120. At a storing step 400 the pre-defined user interface setting for speaker gain is stored in the personalized user interface parameter fields 130. More specifically, in this example, the speaker gain setting is stored in bits 24 to 27 of the personalized user interface field 130 of memory offset addresses 0x001A to 0x001D.

The method 300 then again performs the more settings test 440 to determine if the user inputs a request at the user interface circuitry 102 in order to set more of his/her personal user interface settings. If the user does not require to set any more personal user interface settings the method terminates at the end step 450. However, if the user wishes to set more personal user interface settings then the method 300 again returns to the step of receiving 330 and thereafter the method 300 again performs the determining selection test 340 to determine what user interface selection was chosen by the user.

If for instance, this time the interface selection chosen was “Display” then the method 300 performs a step of adjusting 410 that provides for adjusting interface parameters of the accessory 120 to provide a personalized interface parameter. During adjusting 410 the user has the option to modify the display's settings (typically a Liquid Crystal Display that comprises part of the user interface circuitry 122) including color/grey scale, brightness, contrast and font size. Once the personalized display's settings are adjusted to the requirements of the user, the processor 108 uses the look up table at a generating interface setting step 420 to generate (select) a pre-defined user interface setting for display settings by referring to the personalized interface parameter. At a storing step 430 the pre-defined user interface setting for display settings are stored in the personalized user interface parameter fields 130. More specifically, in this example, the display settings are stored in bits 0 to 23 of the personalized user interface field 130 of memory offset addresses 0x001A to 0x001D.

The method 300 then again performs the more settings test 440 to determine if the user inputs a request at the user interface circuitry 102 in order to set more of his/her personal user interface settings. If the user does not require to set any more personal user interface settings the method terminates at the end step 450.

Advantageously, the present invention provides for automatically personalizing user interface parameters of accessories that are operatively coupled to the two-way radio 100. Also, more than one user of an accessory has been described, each accessory may be owned by an individual user and therefore there will be a single personalization user interface parameter field comprising the speaker, microphone and display settings. Hence, there would be no need for the steps 230, 240 and 250.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims.

1. A communications device for automatically personalizing user interface parameters of an accessory operatively coupled thereto, the communications device comprising:
a processor;
a user interface operatively coupled to the processor; and
an accessory port operatively coupled to the processor, wherein in use when an accessory is operatively coupled to the accessory port the processor provides for reading of at least one pre-defined user interface setting pre-selected by a user of the accessory and stored in a memory of the accessory, and controlling at least one user interface parameter of the accessory, the controlling being effected by the processor in response to the reading of at least one pre-defined user interface setting.

2. A communications device as claimed in claim 1, wherein the pre-defined user interface setting is a pre-defined audio characteristic setting.

3. A communications device as claimed in claim 2, wherein the reading is further characterized by the pre-defined user interface setting including microphone gain.

4. A communications device as claimed in claim 2, wherein the pre-defined audio characteristic settings includes speaker gain.

5. A communications device as claimed in claim 1, wherein the user interface parameter includes an audio parameter.

6. A communications device as claimed in claim 1, wherein the user interface parameter is associated with a visual display.

7. A communications device as claimed in claim 1, wherein the pre-defined user interface setting is stored in the memory of the accessory prior to operative coupling of the accessory to the communications device.

8. A communications device as claimed in claim 1, wherein, the pre-defined user interface setting is selected by:
adjusting an interface parameter of the accessory, the adjusting being performed by a user of the accessory to provide a personalized interface parameter; and
generating the pre-defined user interface setting from personalized interface parameter; and
storing the pre-defined user interface setting.

9. A method for automatically personalizing user interface parameters of an accessory operatively coupled to a communications device, the method comprising:
reading of at least one pre-defined user interface setting stored in a memory of the accessory, the reading being performed by the communications device and the pre-defined user interface settings being pre-selected by a user of the accessory; and
controlling at least one user interface parameter of the accessory, the controlling being effected by the communications device in response to the reading of at least one pre-defined user interface setting.

10. A method as claimed in claim 9, wherein the pre-defined user interface setting is a pre-defined audio characteristic setting.

11. A method as claimed in claim 10, wherein the reading is further characterized by the pre-defined user interface setting including microphone gain.

12. A method as claimed in claim 10, wherein the pre-defined audio characteristic settings include speaker gain.

13. A method as claimed in claim 9, wherein the controlling is characterized by the communications device directly controlling the user interface parameter.

14. A method as claimed in claim 9, wherein, the user interface parameter may include an audio parameter.

15. A method as claimed in claim 9, wherein the user interface parameter is associated with a visual display.

16. A method as claimed in claim 9, wherein the method includes a prior step of detecting operatively coupling of the accessory.

17. A method as claimed in claim 9, wherein the method includes a prior step of obtaining user identification data for identifying the pre-defined user interface settings.

18. A method as claimed in claim 9, wherein, the accessory is addressed by use of an accessory identifier stored in an embedded memory of the accessory.

19. A method as claimed in claim 9, wherein the pre-defined user interface setting is stored in the memory of the accessory prior to operative coupling of the accessory to the communications device.

20. A method as claimed in claim 9, wherein the pre-defined user interface setting is selected by:
adjusting an interface parameter of the accessory, the adjusting being performed by a user of the accessory to provide a personalized interface parameter; and
generating the pre-defined user interface setting from personalized interface parameter; and
storing the pre-defined user interface setting.
